(19) United States
(12) Patent Application Publication
(10) Pub. No.: US 2015/0046831 A1
(43) Pub. Date: Feb. 12, 2015

(54) Method and Apparatus for Unlocking Terminal

(71) Applicant: Huawei Technologies Co., Ltd., Shenzhen (CN)

(72) Inventors: Desheng Liang, Shenzhen (CN); Yuanhong He, Nanjing (CN)

(21) Appl. No.: 14/522,358

(22) Filed: Oct. 23, 2014

Related U.S. Application Data
(63) Continuation of application No. PCT/CN2012/079331, filed on Jul. 30, 2012.

(51) Int. Cl. G06F 3/0484; G06F 3/0486; G06F 3/0482; G06T 13/80; G06F 3/0488; G06F 3/0481

(52) U.S. Cl. CPC G06F 3/04842; G06F 3/0488; G06F 3/04817; G06F 3/0482; G06T 13/80; G06F 3/0486
USPC 715/741

(57) ABSTRACT

Embodiments of the present invention provide a method for unlocking a terminal, which includes: detecting, by a terminal, that a user touches an unlocking icon of the terminal, and playing a spreading animation of an application icon, where the unlocking icon is a graphical and interactive user interface object and is used to interact with the user to unlock the terminal; displaying the application icon at a preset location after the spreading animation is played; when it is detected that the user drags the unlocking icon, moving the unlocking icon according to a dragging track of the user; and when the location of the unlocking icon intersects the location of the application icon, performing an unlocking operation and entering an interface of an application. Correspondingly, the embodiments of the present invention further provide an apparatus for unlocking a terminal, so as to improve the user experience.

This application is a continuation of International Application No. PCT/CN2012/079331, filed on Jul. 30, 2012, which is hereby incorporated by reference in its entirety.

### TECHNICAL FIELD

Embodiments of the present invention relate to the field of communications technologies, and in particular, to a method and an apparatus for unlocking a terminal.

### BACKGROUND

With the development of mobile communications and the continuous improvement of living standards of people, the use of mobile terminals becomes more and more popular, and mobile terminals such as mobile phones and tablet computers have become indispensable communication tools in people's lives.

Currently, full touch terminals become increasingly popular, and especially, intelligent terminals such as Android and IPhone are developed rapidly. In the prior art, unlocking is mainly implemented by a user by moving an unlocking image to a predefined location, or by a user by customizing a track of an unlocking gesture, so that when the user moves an unlocking image to a predefined location through the track, the unlocking operation is completed.

In the prior art, a user can only move an unlocking image to a predefined unlocking location through a predefined track, which leads to a single interface and undesirable user experience.

### SUMMARY

Embodiments of the present invention provide a method and an apparatus for unlocking a terminal, so as to solve the problem of a single unlocking interface and improve user experience.

An embodiment of the present invention provides a method for unlocking a terminal, which includes detecting, by a terminal, that a user touches an unlocking icon of the terminal, and playing a spreading animation of an application icon. The unlocking icon is a graphical and interactive user interface object and is used to interact with the user to unlock the terminal. The method further includes displaying the application icon at a preset location after the spreading animation is played. When it is detected that the user drags the unlocking icon, the unlocking icon is moved according to a dragging track of the user. When the location of the unlocking icon intersects the location of the application icon, an unlocking operation is performed and an interface of the application is entered into.

An embodiment of the present invention further provides a terminal, which includes a detection unit configured to detect that a user touches an unlocking icon of the terminal. The unlocking icon is a graphical and interactive user interface object and is used to interact with the user to unlock the terminal. A playing unit is configured to play a spreading animation of an application icon. A display unit is configured to display the application icon at a preset location after the spreading animation is played. The detection unit is further configured to move the unlocking icon according to a dragging track of the user when it is detected that the user drags the unlocking icon. An unlocking unit is configured to perform an unlocking operation and enter an interface of an application when the location of the unlocking icon intersects the location of the application icon.

In the method for unlocking a terminal according to the embodiments, after detecting that the user presses the unlocking icon, the user releases the unlocking icon, and the user drags the unlocking icon, the terminal performs an operation of playing the spreading animation of the application icon, an operation of playing a recovery animation of the application icon, and an operation of moving the unlocking icon, respectively, and after the user drags the unlocking icon to a unlocking location area for unlocking the icon or an area of the application icon, the terminal performs an unlocking operation and enters the interface of the application. Therefore, the problem of a single unlocking interface is solved and the user experience is improved.

### BRIEF DESCRIPTION OF THE DRAWINGS

To describe the technical solutions in the embodiments of the present invention or in the prior art more clearly, the following briefly introduces the accompanying drawings required for describing the embodiments or the prior art. Apparently, the accompanying drawings in the following descriptions show merely some embodiments of the present invention, and persons of ordinary skill in the art may still derive other drawings from these accompanying drawings without creative efforts.

FIG. 1 is a flowchart of a method according to Embodiment 1 of the present invention;

FIG. 2 is a diagram of an unlocking interface according to Embodiment 1 of the present invention;

FIG. 3 is a flowchart of a method according to Embodiment 2 of the present invention; and

FIG. 4 is a structural diagram of a terminal according to Embodiment 3 of the present invention.

### DETAILED DESCRIPTION OF ILLUSTRATIVE EMBODIMENTS

To make the objectives, technical solutions, and advantages of the embodiments of the present invention more comprehensible, the following clearly and describes the technical solutions in the embodiments of the present invention with reference to the accompanying drawings in the embodiments of the present invention. Apparently, the described embodiments are merely a part of the embodiments of the present invention rather than all of the embodiments. All other embodiments obtained by persons of ordinary skill in the art based on the embodiments of the present invention without creative efforts shall fall within the protection scope of the present invention.

### Embodiment 1

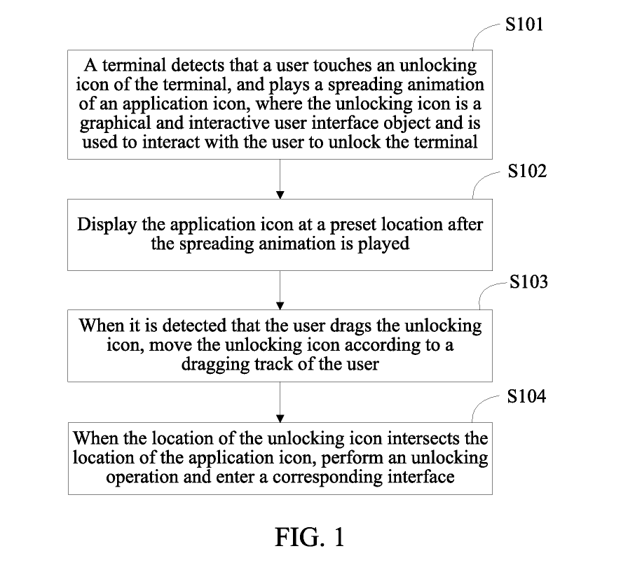

FIG. 1 is a flowchart of an embodiment of a method for unlocking a terminal according to the present invention. As shown in FIG. 1, the method may include:

S101: A terminal detects that a user touches an unlocking icon of the terminal, and plays a spreading animation of an application icon, where the unlocking icon is a graphical and interactive user interface object and is used to interact with the user to unlock the terminal.

Detecting, by the terminal, that the user touches the unlocking icon of the terminal and playing the spreading animation of the application icon specifically includes that: when the user touches the unlocking icon of the terminal, multiple application icons are separated from the unlocking icon, and the multiple application icons spread in preset directions. An icon may be in the shape of a droplet, or in the shape of a flower, or the like, and the shape of the application icon is not limited in the embodiment of the present invention. It is taken as an example that the unlocking icon and the application icon are both in the shape of a droplet, and playing the spreading animation of the application icon is playing a droplet spreading animation. The specific implementation may be loading images of droplets at different locations, displaying, frame by frame, images of multiple droplets spreading to different locations, and hiding an image of a droplet in a previous frame, so as to achieve an effect that different droplets spread according to their respective fixed tracks.

It should be noted that, before the user touches the unlocking icon of the terminal, the user may further activate gravity sensing and a blowing mode on the terminal, and set a gravity sensing sensitivity and a blowing sensitivity on a setting interface. Either of the gravity sensing and the blowing mode may be activated, or both of the gravity sensing and the blowing mode may be activated.

After the gravity sensing is activated and the gravity sensing sensitivity is set, when the interface is locked, the user shakes the terminal, and the terminal calculates the amplitude of shaking up and down or from side to side in a unit of time and determines whether the amplitude exceeds a preset gravity sensing sensitivity, if yes, plays an animation that droplets quiver; if not, does not play the animation. The details are described as follows. The terminal obtains its own location coordinates in a physical space and calculates variation values of the coordinates in a unit of time. Taking (x, y, z) axes for example, when the terminal is horizontally placed with its screen facing upward (the z axis directs upward), the values of (x, y, z) are (0, 0, 10). When the terminal is horizontally placed with its screen facing downward (the z axis directs downward), the values of (x, y, z) are (0, 0, −10). When the terminal is laterally placed with its screen facing the left side (the x axis directs upward), the values of (x, y, z) are (10, 0, 0). When the terminal is vertically placed upward (the y axis directs upward), the values of (x, y, z) are (0, 10, 0). If in a unit of time, the variation of the horizontal coordinate location of the terminal is larger than the preset gravity sensing sensitivity, the terminal plays an animation that the droplets quiver from side to side. If in a unit of time, the variation of the vertical coordinate location of the terminal is larger than the preset gravity sensing sensitivity, the terminal plays an animation that the droplets quiver up and down.

After the blowing mode is activated and the sensitivity is set, the terminal obtains the volume of an input audio, where the volume of the input audio may be the volume of an audio that the user blows to a microphone. If in a period of time, the volume of the audio is larger than the preset sensitivity, the terminal plays an animation that the droplets ripple on an unlocking interface, while if the volume of the audio does not exceed the preset sensitivity, the terminal does not play the animation.

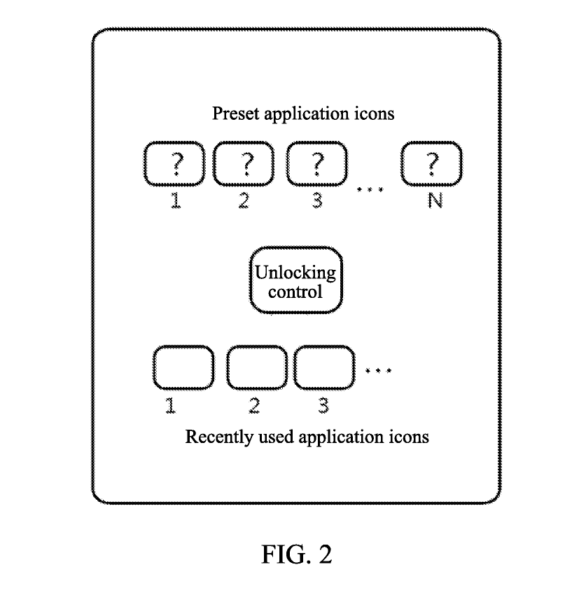

S102: Display the application icon at a preset location after the animation is played. The terminal displays the application icon after the droplet spreading animation is played, where the application icon includes one or more application icons preset by the user, or includes one or more recently used application icons, and the terminal may display one or more preset application icons and one or more recently used application icons on the unlocking interface as shown in FIG. 2.

S103: When it is detected that the user drags the unlocking icon, move the unlocking icon according to a dragging track of the user.

The user drags the unlocking icon, and at this time, the terminal detects that the user drags the unlocking icon and moves the unlocking icon according to the dragging track of the user.

If the user suddenly releases the unlocking icon in the dragging process, after detecting that the user releases the unlocking icon, the terminal hides the application icon and plays a droplet recovery animation.

S104: When the location of the unlocking icon intersects the location of the application icon, perform an unlocking operation and enter an interface of the application.

The terminal needs to determine whether the current location of the unlocking icon intersects the location of the application icon, where the intersection may be that the contour of the unlocking icon intersects the contour of the application icon, or may be that the unlocking icon partially overlaps the application icon and the specific size of the overlapped part may be set in advance. The location of the unlocking icon intersects the location of the application icon, so that an interface of the corresponding application is entered after unlocking. For example, if the application icon is an icon of a photographic program, the photographic program is activated after unlocking; if the application icon is an icon of a main interface, the main interface is entered after unlocking.

In the embodiment of the present invention, the unlocking icon and the application icon are both in the shape of a droplet, and when the location of the unlocking icon intersects the location of the application icon, the unlocking icon is combined with the application icon, and the effect that two droplets are merged appears on the unlocking interface.

In the method for unlocking a terminal according to this embodiment, after detecting that the user presses the unlocking icon, the user releases the unlocking icon, and the user drags the unlocking icon, the terminal performs an operation of playing the spreading animation of the application icon, an operation of playing the recovery animation of the application icon, and an operation of moving the unlocking icon, respectively, and after the user drags the unlocking icon to a unlocking location area for unlocking the icon or an area of the application icon, the terminal performs an unlocking operation and enters the interface of the application. Therefore, the problem of a single unlocking interface is solved and the user experience is improved.

### Embodiment 2

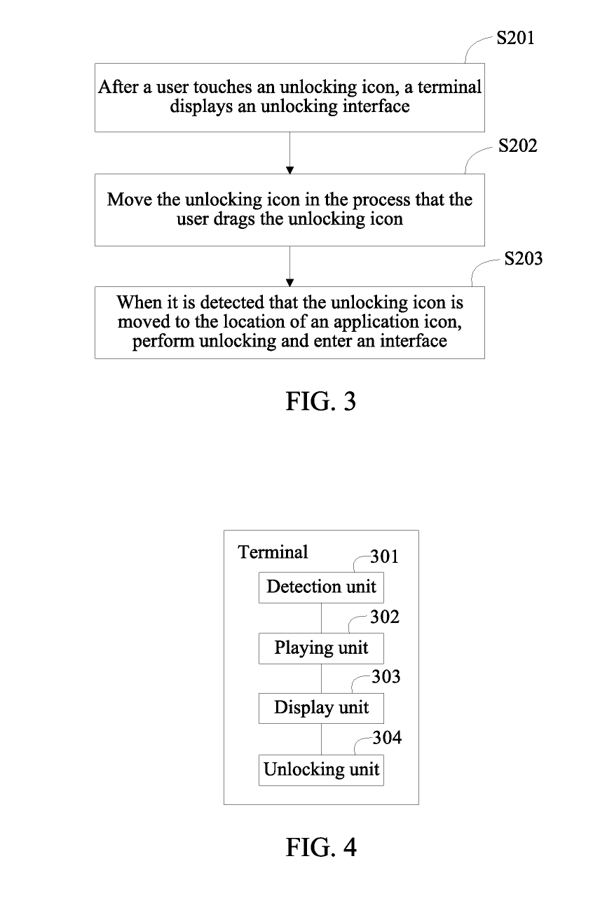

As shown in FIG. 3, in this embodiment, a process of a method for unlocking a terminal is described as follows.

S201: After a user touches an unlocking icon, a terminal displays an unlocking interface.

After the terminal is switched on or the screen of the terminal in a locking state is activated by clicking, the terminal displays a pre-unlocking interface. In the embodiment of the present invention, the pre-unlocking interface has an unlocking icon, and optionally, may further display time. The unlocking icon is a graphical and interactive user interface object and is used to interact with the user to unlock the terminal. The terminal detects that the user touches the unlocking icon of the terminal and plays a spreading animation of an application icon. An icon may be in the shape of a droplet, or in the shape of a flower, or the like, and the shape of the application icon is not limited in the embodiment of the present invention. It is taken as an example that the application icon is in the shape of a droplet, and when the user touches the unlocking icon of the terminal, multiple droplets are separated from the unlocking icon, and the multiple droplets spread in preset directions. The specific implementation is described as follows. The user presses the unlocking icon, and the terminal plays a droplet spreading animation. The specific implementation may be loading images of droplets at different locations, displaying, frame by frame, images of multiple droplets spreading to different locations, and hiding an image of a droplet in a previous frame, so as to achieve an effect that different droplets spread according to their respective fixed tracks. It should be noted that, in the embodiment of the present invention, the unlocking icon is in the shape of a droplet. The terminal displays the application icon after the droplet spreading animation is played, where the application icon includes an application icon preset by the user on a setting interface, and further includes a recently used application icon, and the terminal may display one or more preset application icons and one or more recently used application icons.

If the user suddenly releases the unlocking icon in the process that the terminal plays the droplet spreading animation, the terminal plays a droplet recovery animation, which is reverse to the moving direction of the droplet spreading animation and the implementation manner is the same as that of the droplet spreading animation. After the droplet recovery animation is played, the terminal plays a rippling animation after the recovery. That is, the droplets slightly and repeatedly bounce around for a period of time, and its implementation method is the same as that of the droplet spreading animation. After the rippling animation is played, if the user presses the unlocking icon again, the terminal replays the droplet spreading animation. It should be noted that, if the user suddenly presses the unlocking icon in the process that the terminal plays the droplet recovery animation, the terminal continuously plays the droplet recovery animation and performs no processing on a message response or an event of pressing, by the user, the unlocking icon.

It should be noted that, the user may further preset to activate gravity sensing and a blowing mode, and set a gravity sensing sensitivity and a blowing sensitivity on a setting interface. Either of the gravity sensing and the blowing mode may be activated, or both of the gravity sensing and the blowing mode may be activated.

After the gravity sensing is activated and the sensitivity is set, the user shakes the terminal, and the terminal monitors the change of the gravity sensing through a built-in sensor, calculates the amplitude of shaking, and determines whether the amplitude exceeds a preset gravity sensing sensitivity, if yes, plays an animation that droplets quiver on the unlocking interface; if not, does not play the animation. The details are described as follows. Taking (x, y, z) axes for example, when the terminal is horizontally placed with its screen facing upward (the z axis directs upward), the values of (x, y, z) are (0, 0, 10). When the terminal is horizontally placed with its screen facing downward (the z axis directs downward), the values of (x, y, z) are (0, 0, −10). When the terminal is laterally placed with its screen facing the left side (the x axis directs upward), the values of (x, y, z) are (10, 0, 0); and when the terminal is vertically placed upward (the y axis directs upward), the values of (x, y, z) are (0, 10, 0). If the variation of the horizontal coordinate location of the terminal is larger than the preset sensitivity, the terminal plays an animation that the droplets quiver from side to side; if the variation of the vertical coordinate location of the terminal is larger than the preset sensitivity, the terminal plays an animation that the droplets quiver up and down.

After the blowing mode is activated and the blowing sensitivity is set, the user blows to a microphone module of the terminal, and the terminal monitors a variation value of an audio that the user blows. If in a period of time, the volume of the audio is larger than a preset blowing sensitivity, the terminal plays an animation that the droplets ripple on the unlocking interface, while if the volume of the audio does not exceed the preset blowing sensitivity, the terminal does not play the animation.

S202: Move the unlocking icon in the process that the user drags the unlocking icon.

After the user touches a trigger area of the unlocking interface of the terminal and the droplet spreading animation is played, the terminal displays the application icon. At this time, the terminal detects that the user drags the unlocking icon, and moves location coordinates of the unlocking icon. In the embodiment of the present invention, moving the location coordinates of the unlocking icon by the terminal may be monitoring a moving event of an unlocking control, recording the unlocking control in real time, and invoking a system function to re-draw the unlocking control at new location coordinates.

If in the moving process, the user suddenly releases the unlocking icon, and after the terminal receives an instruction that the user releases the unlocking icon, the terminal plays the droplet recovery animation.

S203: When it is detected that the unlocking icon is moved to the location of the application icon, perform unlocking and enter a corresponding interface.

In the process that the user drags the unlocking icon, the terminal further needs to determine whether the current location of the unlocking icon intersects the location area of the application icon, where the intersection may be that the contour of the unlocking icon intersects the contour of the application icon, or may be that the unlocking icon partially overlaps the application icon and the specific size of the overlapped part may be set in advance. The location of the unlocking icon intersects the location of the application icon, so that an interface of the corresponding application is entered after unlocking. For example, if the application icon is an icon of a photographic program, the photographic program is activated after unlocking; if the application icon is an icon of a main interface, the main interface is entered after unlocking. In the embodiment of the present invention, the unlocking icon and the application icon are both in the shape of a droplet, and when the location of the unlocking icon intersects the preset location of the application icon, the unlocking icon is combined with the application icon, and the effect that two droplets are merged appears on the unlocking interface.

In the method for unlocking a terminal according to this embodiment, after detecting that the user presses the unlocking icon, the user releases the unlocking icon, and the user drags the unlocking icon, the terminal performs an operation of playing the spreading animation of the application icon, an operation of playing the recovery animation of the application icon, and an operation of moving the unlocking icon, respectively, and after the user drags the unlocking icon to a unlocking location area for unlocking the icon or an area of the application icon, the terminal performs an unlocking operation and enters the interface of the application. Therefore, the problem of a single unlocking interface is solved and the user experience is improved.

### Embodiment 3

An embodiment of the present invention provides a terminal, as shown in FIG. 4, which includes the following units.

A detection unit 301 is configured to detect that a user touches an unlocking icon of the terminal, where the unlocking icon is a graphical and interactive user interface object and is used to interact with the user to unlock the terminal.

A playing unit 302 is configured to play a droplet spreading animation.

Detecting, by the detection unit 301, that the user touches the unlocking icon of the terminal and playing, by the playing unit 302, a spreading animation of an application icon is specifically that: when the user touches the unlocking icon of the terminal, multiple application icons are separated from the unlocking icon, and the multiple application icons spread in preset directions. An icon may be in the shape of a droplet, or in the shape of a flower, or the like, and the shape of the application icon is not limited in the embodiment of the present invention. It is taken as an example that the unlocking icon and the application icon are both in the shape of a droplet, and that the playing unit 302 plays the spreading animation of the application icon is playing the droplet spreading animation. The specific implementation may be loading images of droplets at different locations, displaying, frame by frame, images of multiple droplets spreading to different locations, and hiding an image of a droplet in a previous frame, so as to achieve an effect that different droplets spread according to their respective fixed tracks.

It should be noted that, a setting unit of the terminal may activate gravity sensing and a blowing mode, and set a gravity sensing sensitivity and a blowing sensitivity. Either of the gravity sensing and the blowing mode may be activated, or both of the gravity sensing and the blowing mode may be activated.

After the gravity sensing is activated and the gravity sensing sensitivity is set, on an unlocking interface, the user shakes the terminal, and the terminal monitors the change of the gravity sensing through a built-in sensor module, a calculation unit calculates the amplitude of shaking up and down or from side to side in a unit of time, a judgment unit determines whether the amplitude exceeds a preset gravity sensing sensitivity, and if yes, the playing unit plays an animation that droplets quiver; if not, does not play the animation. The details are described as follows. The calculation unit of the terminal obtains its own location coordinates in a physical space and calculates variation values of the coordinates. Taking (x, y, z) axes for example, when the terminal is horizontally placed with its screen facing upward (the z axis directs upward), the values of (x, y, z) are (0, 0, 10). When the terminal is horizontally placed with its screen facing downward (the z axis directs downward), the values of (x, y, z) are (0, 0, −10); when the terminal is laterally placed with its screen facing the left side (the x axis directs upward), the values of (x, y, z) are (10, 0, 0); and when the terminal is vertically placed upward (the y axis directs upward), the values of (x, y, z) are (0, 10, 0). If the variation of the horizontal coordinate location of the terminal is larger than the preset gravity sensing sensitivity, the playing unit plays an animation that the droplets quiver from side to side; if the variation of the vertical coordinate location of the terminal is larger than the preset gravity sensing sensitivity, the playing unit plays an animation that the droplets quiver up and down.

After the blowing mode is activated and the sensitivity is set, an obtaining unit of the terminal obtains the volume of an input audio, where the volume of the input audio may be the volume of an audio that the user blows to a microphone. If in a period of time, the volume of the audio is larger than a preset sensitivity, the playing unit plays an animation that the droplets ripple, while if the volume of the audio does not exceed the preset sensitivity, the playing unit does not play the animation.

A display unit 303 is configured to display the application icon at a preset location after the animation is played.

The display unit 303 of the terminal displays the application icon after the playing unit 302 plays the droplet spreading animation, where the application icon includes one or more application icons preset by the user, and further includes one or more recently used application icons, and the display unit 303 may display one or more preset application icons and one or more recently used application icons. The detection unit 301 is further configured to: when it is detected that the user drags the unlocking icon, move the unlocking icon according to a dragging track of the user.

After the playing unit 302 plays the droplet spreading animation, the user drags the unlocking icon, and the detection unit 304 of the terminal detects that the user drags the unlocking icon and the detection unit moves the unlocking icon according to the dragging track of the user.

If the user suddenly releases the unlocking icon in the dragging process, after the detection unit 304 of the terminal detects that the user releases the unlocking icon, a hiding unit hides the application icon and the playing unit plays a droplet recovery animation.

An unlocking unit 304 is configured to: when the location of the unlocking icon intersects the preset location of the application icon, perform an unlocking operation and enter an interface of the application.

The judgment unit of the terminal determines whether the current location of the unlocking icon intersects the preset location of the application icon, where the preset location may be that the contour of the unlocking icon intersects the contour of the application icon, or may be that the unlocking icon partially overlaps the application icon and the specific size of the overlapped part may be set in advance. The location of the unlocking icon intersects the preset location of the application icon, so that the unlocking unit 304 enters an interface of the corresponding application after unlocking. For example, if the application icon is an icon of a photographic program, the photographic program is activated after unlocking; if the application icon is an icon of a main interface, the main interface is entered after unlocking.

In the embodiment of the present invention, the unlocking icon and the application icon are both in the shape of a droplet, and when the location of the unlocking icon intersects the preset location of the application icon, the unlocking unit 304 combines the unlocking icon with the application icon, and the effect that two droplets are merged appears on the unlocking interface.

According to the terminal provided by this embodiment, after the detection unit detects that the user presses the unlocking icon, the user releases the unlocking icon, and the user drags the unlocking icon, the playing unit performs an operation of playing the spreading animation of the application icon, an operation of playing the recovery animation of the application icon, and an operation of moving the unlocking icon, respectively, and after the user drags the unlocking icon to a unlocking location area for unlocking the icon or an area of the application icon, the unlocking unit performs an unlocking operation and enters the interface of the application. Therefore, the problem of a single unlocking interface is solved and the user experience is improved.

It may be clearly understood by persons skilled in the art that, for the purpose of convenient and brief description, reference may be made to the corresponding processes in the method embodiments for the specific working processes of the foregoing system, device, and units, and details are not elaborated herein.

It should be understood by persons of ordinary skill in the art that the accompanying drawings are merely schematic diagrams of an embodiment, and units or procedures in the accompanying drawings are not necessarily required in implementing the present invention.

In the embodiments provided in the present application, it should be understood that the disclosed system, device, and method may be implemented in other manners. For example, the described device embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connection may be implemented through some interfaces. The indirect couplings or communication connections between devices or units may be implemented in electronic, mechanic, or other forms.

The units described as separate parts may be or may not be physically separate, and parts displayed as units may be or may not be physical units, that is, may be located in one position, or may be distributed on multiple network elements. A part or all of the units may be selected according to actual needs to achieve the objectives of the solutions of the embodiments.

In addition, various functional units according to each embodiment of the present invention may be integrated in one processing unit or may exist as various separate physical units, or two or more units may be integrated in one unit. The integrated unit may be implemented through hardware, or may be implemented in a form of hardware plus a software functional unit.

The integrated unit implemented through a software functional unit may be stored in a computer readable storage medium. The foregoing software functional unit is stored in a storage medium, including several instructions for instructing a computer device (which may be a personal computer, a server, a network device, or the like) to perform a part of steps in the methods described in the embodiments of the present invention. The storage medium includes various media that can store program codes, such as a USB flash drive, a mobile hard disk, a read-only memory (Read-only Memory, ROM for short), a random access memory (Random Access Memory, RAM for short), a magnetic disk, or an optical disk.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof; and these modifications or replacements do not make the essence of the corresponding technical solutions depart from the idea and scope of the technical solutions of the embodiments of the present invention.

What is claimed is:

1. A method for unlocking a terminal, the method comprising:
detecting, by a terminal, that a user touches an unlocking icon of the terminal, and playing a spreading animation of an application icon, wherein the unlocking icon is a graphical and interactive user interface object and is used to interact with the user to unlock the terminal;
displaying the application icon at a preset location after the spreading animation is played;
detecting whether the user drags the unlocking icon, wherein when it is detected that the user drags the unlocking icon, moving the unlocking icon according to a dragging track of the user; and
detecting whether a location of the unlocking icon intersects the location of the application icon, wherein when the location of the unlocking icon intersects the location of the application icon, performing an unlocking operation and entering an interface of the application.

2. The method according to claim 1, wherein the application icon comprises one or more preset application icons and one or more recently used application icons.

3. The method according to claim 1, wherein before the location of the unlocking icon intersects the location of the application icon, the method further comprises playing, by the terminal, a recovery animation of the application icon when the user releases the unlocking icon.

4. The method according to claim 1, wherein before the detecting that the user touches the unlocking icon of the terminal, the method further comprises:
obtaining, by the terminal, its own location coordinates in a physical space, and calculating variation values of the coordinates; and
when a variation value of a coordinate is larger than a preset gravity sensing sensitivity, playing, by the terminal, an animation that droplets quiver.

5. The method according to claim 4, wherein when the variation value of the coordinate is larger than the preset gravity sensing sensitivity, the playing, by the terminal, the animation that the droplets quiver comprises:
when a variation value of a horizontal coordinate is larger than the preset gravity sensing sensitivity, playing, by the terminal, an animation that the droplets quiver from side to side.

6. The method according to claim 4, wherein when the variation value of the coordinate is larger than the preset gravity sensing sensitivity, the playing, by the terminal, the animation that the droplets quiver comprises:
when a variation value of a vertical coordinate is larger than the preset gravity sensing sensitivity, playing, by the terminal, an animation that the droplets quiver up and down.

7. The method according to claim 1, wherein before the detecting that the user touches the unlocking icon of the terminal, the method further comprises:
obtaining, by the terminal, volume of an input audio, and when the volume of the input audio is larger than a preset blowing sensitivity, playing, by the terminal, the animation that the droplets quiver.

8. The method according to claim 1, wherein before the playing the spreading animation of the application icon, the method further comprises:
separating the application icon from the unlocking icon.

9. The method according to claim 1, wherein when the location of the unlocking icon intersects the location of the application icon, the unlocking icon is combined with the application icon, the unlocking operation is performed, and the interface of the application is entered.

10. The method according to claim 1, wherein the location of the unlocking icon intersecting the location of the application icon comprises:
a contour of the unlocking icon intersecting a contour of the application icon, or the unlocking icon partially overlapping a preset location area of the application icon.

11. The method according to claim 1, wherein the moving the unlocking icon comprises:
recording in real time a location to which the user drags the unlocking icon, and re-drawing the unlocking icon at location coordinates dragged to by the user.

12. A terminal comprising:
a playing unit configured to play a spreading animation of an application icon;
a display unit configured to display the application icon at a preset location after the spreading animation is played, wherein
a detection unit configured to
detect that a user touches an unlocking icon of the terminal, wherein the unlocking icon is a graphical and interactive user interface object and is used to interact with the user to unlock the terminal;
move the unlocking icon according to a dragging track of the user when it is detected that the user drags the unlocking icon; and
an unlocking unit configured to perform an unlocking operation and enter an interface of an application when a location of the unlocking icon intersects the location of the application icon.

13. The terminal according to claim 12, wherein the application icon comprises one or more preset application icons and one or more recently used application icons.

14. The terminal according to claim 12, wherein the playing unit is further configured to:
when the user releases the unlocking icon, play a recovery animation of the application icon.

15. The terminal according to claim 12, further comprising:
a calculation unit configured to obtain its own location coordinates in a physical space and calculate variation values of the coordinates, wherein the playing unit is further configured to play an animation that droplets quiver when a variation value of a coordinate is larger than a preset gravity sensing sensitivity.

16. The terminal according to claim 12, further comprising:
an obtaining unit configured to obtain volume of an input audio, wherein the playing unit is further configured to play the animation that the droplets quiver when the volume of the input audio is larger than a preset blowing sensitivity.

17. The terminal according to claim 12, further comprising:
a separation unit configured to separate the application icon from the unlocking icon.

18. The terminal according to claim 12, wherein when the location of the unlocking icon intersects the location of the application icon, the unlocking unit combines the unlocking icon with the application icon, performs the unlocking operation, and enters the interface of the application.
